(19) United States
(12) Patent Application Publication
(10) Pub. No.: US 2002/0032659 A1
(43) Pub. Date: Mar. 14, 2002

(54) System and method for obtaining and developing technology for market

(76) Inventor: Michael Waters, West Dundee, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/771,865

(22) Filed: Jan. 29, 2001

Related U.S. Application Data
(60) Provisional application No. 60/178,366, filed on Jan. 27, 2000.

(51) Int. Cl. G06F 17/60

(52) U.S. Cl. 705/54

(57) ABSTRACT

A method and system are provided for obtaining new ideas from independent sources and integrating the inputs of experts across a range of technologies and product development areas in a networked environment, whereby the idea is transformed and developed into one or more patented technologies that is preferably applicable in a broad range of commercial applications. A networked system such as the Internet for communications between developers and technology consumer business entities allows for idea generation with input or suggestions being gathered from multiple sources. The method maximizes the generation of revenue from ideas by strategic targeting of potential licensees of the resulting patented technology by facilitating communication and particularly electronic communications between technology developers and end-user companies requiring the applications of technologies to novel products and designs. To this end, patent protection for the idea is maximized, as described, and the patents are pooled in a networked system to provide potential licensors with ready access to large numbers of high-value patents covering diverse technologies.

### BACKGROUND OF THE INVENTION

The present invention provides an information processing system and method in a network computer environment for obtaining ideas from independent outside sources and developing those ideas to maximize their commercial value and to generate highly desirable patented technology. The system herein further provides a networked marketing system for maximizing the economic return obtained for the patented technology.

As the world's economy continues to become more technology driven, the value of products now lies not so much in their physical characteristics but instead is derived more from the creativity involved in their conception, development and production. For instance, while the actual weight of the Gross National Product (GNP) has not changed much over the last several years, there has been a significant rise in the GNP that can be primarily attributed to the conceptual components associated with the goods. As is apparent, this underscores the importance of intellectual property and the major portion of the economy it has assumed. In this regard, intellectual property has become a highly valued global commodity, but the rights to specific technology generally are still limited by national borders. This limitation creates conflicts between industrialized countries whose companies own most of the protected intellectual property and developing countries whose aim is often to obtain protected technologies quickly and cheaply despite the rights of intellectual property holders. Generally, statistics indicate that the level of economic benefit or development that a state experiences roughly corresponds to the level of intellectual property protection they provide. While it is true that many developing countries recognize this correlation and have taken measures to beef up their laws on protection and enforcement of intellectual property, a disparity still remains.

Individuals and businesses with limited resources frequently conceive of new and useful products, designs, materials, compositions, and methods which potentially qualify for patent protection under the laws of the United States and numerous foreign countries. Unfortunately, originators of such ideas often do not possess the expertise to strategically develop the concept into broad, commercially valuable patents. In the worst case, the inexperienced idea originator may unwittingly engage in activities which later preclude patent protection altogether. Alternatively, the originator may attempt to obtain patent protection without the assistance of professional legal expertise, often with the result of obtaining no patent, a patent which is easily avoided, or a patent of questionable validity and commercial value. Those that seek professional legal advice frequently do so without having adequately analyzed the potential market for the idea, all of the commercial products in which it may be applicable, the costs of developing and selling such products, or the host of other factors which affect the idea's commercial value, and the optimal strategy for exploiting that value. Because legal costs must often be kept to a minimum, patent attorneys retained in this capacity often must rely on the originator's limited commercialization and business experience when attempting to obtain an appropriate scope of protection for the idea, without the benefit of knowing the full scope of commercial potential for the idea.

With respect to individuals who may be inexperienced in protecting their ideas, lack the financial resources to seek appropriate protection for their ideas, and/or do not have access to vehicles for protecting and marketing their ideas, these types of persons are often located in non-industrialized or developing countries without access to major markets and companies and where patent laws may be marginally effective or weakly enforced, as previously discussed. Further, the businesses that are in the area do not respect intellectual property rights and thus do not typically license products or processes and their associated patent protection, if any, particularly from individuals who might approach them with technology for licensing. Unfortunately, simply because of their location, some of the most creative individuals do not have outlets to properly exploit their ideas.

Even if they do obtain patent protection for their invention, oftentimes the independent inventor is under the mistaken assumption that once a patent is issued to them, the majority of their work is completed in terms of obtaining the desired economic return for their invention, i.e., the patent will sell their product. Unfortunately, this is not the case and the patent is all too often but just one tool in their arsenal for marketing the invention. As discussed above, the patent can be more or less of a factor in the invention marketing depending on how well-thought out the patent strategy was in light of prevailing market considerations. The present system seeks to maximize the effect the patent has on the ability to market the invention and the economic gains had thereon.

On the other hand, some larger corporations may internally practice invention processing procedures by which potentially patentable ideas are reviewed by committees of engineering, marketing and legal professionals in an effort to align the corporate patent business strategies. Such invention review processes are inherently limited, however, in that the focus is on potential commercialization of the idea within the framework of the company's business, without considering input from experts in other businesses and industries.

What often happens is companies decide to forego pursuing new product ideas and protection therefor because they do not fall within their strategies for the future direction of company growth or they do not neatly fall within a family of products which form the core technology of the company. Even if a company does obtain a patent, it may be allowed to lapse prior to completing its full term as by not paying its maintenance or annuity fees for the above-described reasons.

Another problem facing larger companies is their patent portfolio can become so large that they lose handle on exactly what products and in which markets they have exclusive rights. It is known that on an annual basis U.S. corporations lose billions of dollars in potential licensing revenue because of lack of enforcement of their intellectual property rights.

Start-up companies usually begin around a single product or process. Their future growth can depend on any number of factors associated with their market and their ability to take advantage of opportunities as they present themselves. To this end, even established and large companies must be able to respond quickly to market forces and the needs of their customers. Usually, this means that companies have to be able to deliver innovative products to the market on a fairly regular basis, and thus requires that companies have frequent access to fresh ideas. These ideas may be difficult to develop for a number of reasons including lack of R & D resources such as with small start-ups, or because of an unduly narrow focus and/or expertise in a core technology such as with R & D groups at more established or larger companies.

Accordingly, many potentially patentable ideas never are pursued or they enter the patenting process without the benefits of sufficient up-front technology, commercialization, and marketing analysis necessary to maximize the potential value of the patent or patents ultimately obtained. Considering the substantial cost associated with the patenting process, obtaining a “paper patent” on technology having little or no commercial potential can be a very poor investment. A further problem resides in the ability of companies to rapidly respond to market needs with innovative products via their internal resources. Thus, there is a present need for a method of obtaining and developing ideas from multiple independent sources into patented technology having a maximum commercial interest and value. These sources should include those that may be remotely located with respect to access to markets for their ideas and/or companies who can exploit their ideas, e.g. in developing countries. There is a further need for a method of developing such ideas into valuable commercial applications preferably across a wide range of industries.

### SUMMARY OF THE INVENTION

The present invention provides a method and system for obtaining new ideas from independent sources and integrating the inputs of experts across a range of technologies and product development areas in a networked environment, whereby the idea is transformed and developed into one or more patented technologies that is preferably applicable in a broad range of commercial applications. A networked system such as the Internet for communications between developers and technology consumer business entities allows for idea generation with input or suggestions being gathered from multiple sources. The method maximizes the generation of revenue from ideas by strategic targeting of potential licensees of the resulting patented technology by facilitating communication and particularly electronic communications between technology developers and end-user companies requiring the applications of technologies to novel products and designs. To this end, patent protection for the idea is maximized, as described, and the patents are pooled in a networked system to provide potential licensors with ready access to large numbers of high-value patents covering diverse technologies. Further, because of the ability to pool patents to expose them to large numbers of potential licensors, the system of the invention allows for purchase of potentially large numbers of patents from a company's portfolio, such as those patents that are not being exploited because, for example, they do not relate to their core technology. Whereas the seller company may not be able to justify efforts to exploit particular patents directed to non-core technologies, the system herein enables this risk to be assumed due to the large numbers of patents or ideas it presents for sale to the wide variety of potential licensors that will be accessing the system for purchasing technology. Alternatively, a company can use the system experts to manage their entire patent portfolio, as more fully described hereinafter.

The present invention also contemplates client companies being able to solicit ideas for products that they believe they can effectively market or that they anticipate needing to effectively compete. These ideas enter the system of the present invention with the solicitor company given enhanced opportunity to purchase the same, either prior to, during or after the expert inputs for targeting markets and maximizing commercial value thereof. For instance, as ideas enter the system in specific response to the requested innovation posted on the system's web site by a soliciting company, that company can be given a right of first refusal, which may be only effective for only a limited time, in terms of their ability to purchase or license the idea vis-a-vis other interested companies. In other words, if the soliciting company does not immediately purchase or license the idea, then it can proceed through the system as any other submitted idea would for being patented and offered for sale or license during and after this process.

Consistent with the above, the present system also contemplates sales or license of technology know-how; that is, the ideas that enter the system can be made available prior to patenting to companies who have agreed to confidentially and subject to the submitter's approval. The offered ideas can be in their submitted form or be at various stages of refinement by the system and method of integrated expert inputs of the present invention, as will be described hereinafter. The purchasing companies have the option upon agreement for appropriate reimbursement to the system proprietor of continuing use of the system and method herein to maximize patent protection for the idea they purchase or license.

### BRIEF DESCRIPTION OF THE FIGURES

FIGS. 1 and 2 are flow diagrams of the system and method in accordance with the present invention showing the intake of ideas which are transformed into marketable ideas and/or patents therefor and made available in a manner to maximize revenue realized therefrom.

### DETAILED DESCRIPTION OF THE PREFERRED EMBODIMENTS

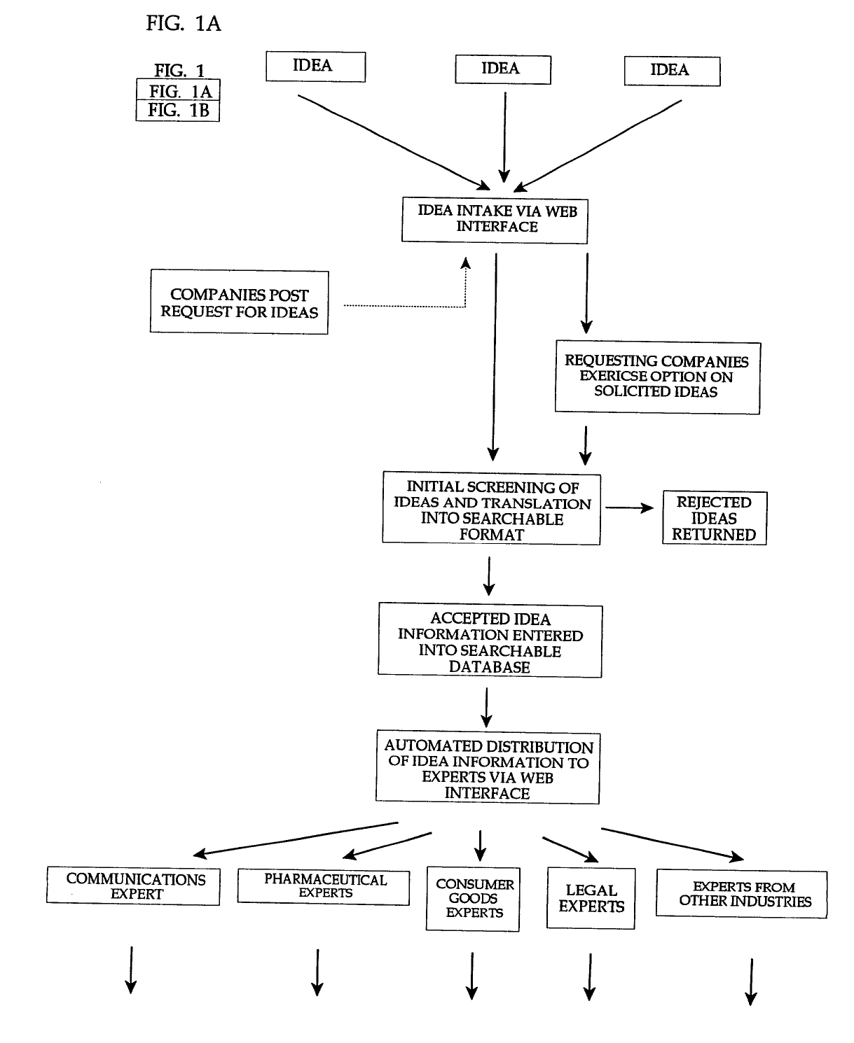

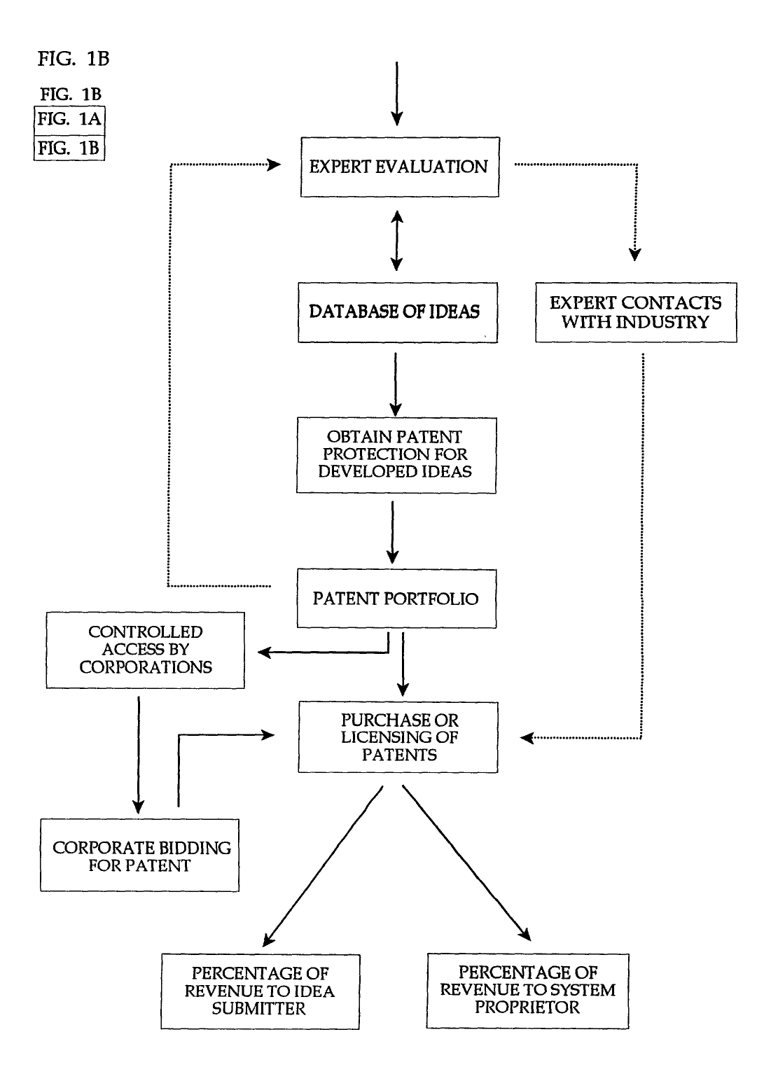

In one aspect of the present invention, the method involves establishing a database of potentially patentable ideas by inviting inputs of information packets from multiple remote originators in a networked computer environment, e.g. terms Internet, as shown in FIG. 1. Because of the almost unlimited reach of the Internet, the system of the present invention affords those creative individuals who previously have lacked access to major markets and companies the opportunity to take advantage of the wide-spread exposure their idea will receive with the present system. In addition, those individuals who have lacked access to appropriate legal services for financial or other reasons will have their ideas run through the present system to optimize their commercial worth and to be protected via patents (U.S. and/or foreign patents as marketing strategies may dictate) without the need to incur out-of-pocket expenses. Their only cost is in the revenue sharing from their idea with the system proprietor, as discussed below.

A computer interface, accessible on the world wide web, permits a remote originator to submit an idea or information packet into the database together with the originators' identifications and contact information. Herein, the terms idea and information packet are used interchangeably to denote disclosures of innovations and associated materials received therewith from submitters. Submission of such ideas is encouraged by offering originators a percentage of the revenue generated from the eventual sale or licensing of know-how or patented technology embodying the further developed forms or embodiments of the original idea. The computer interface allows the user to provide the information packet in text form and/or through the submission of scanned drawings or digitally via CAD (Computer Aided Design) data files. The interface also permits the originator to input other information relevant to the patentability of the idea, such as dates relating to the conception or any public disclosure of the idea, related products embodying similar concepts, etc. Alternatively, the idea may be solicited and received by other means, such as by telephone, facsimile, or in person meeting, with the relevant information input into the database manually.

For protection for both the idea submitter and the proprietors of the present system, encryption software is preferably utilized in transfer of information between the parties over the Internet. The software along with an agreement regarding initial evaluation, subsequent strategic development, and revenue sharing can be provided to the submitter by the present system automatically when they generate an inquiry of the system regarding sending of an information packet for evaluation. To protect the system proprietors against charges of misappropriation, receipts are generated when the submitter makes their initial inquiry, and upon other material communications thereafter. In this regard, for each of the communications, the submitter can be made responsible for asking for a receipt with knowledge that if such a request is not made, the communication and any underlying information sent therewith will not have the guarantee of confidentiality that will attach to other communications where the request is made. Accordingly, encryption techniques available with electronic communications and receipts may be used to maintain the confidentiality and the integrity of property rights of both the contributors and the system proprietor.

More particularly, it is preferred that for every transmission in either direction there is a system whereby each party must agree to either accept information before receiving and must also accept conditions before sending. These transaction receipts are archived in both systems and are part and parcel to the encryption software system. This system is also used internal to the company implementing the present system and method so that all disclosures and access and work is tracked and archived.

As is further shown in FIG. 1, the database of submitted ideas created in this manner is accessible by one or more screening experts, who review each idea preliminarily to identify those that may be patentable and lead to a reasonable level of commercial interest. Throughout the initial and subsequent evaluations of an idea, if any, the submitter and screening expert can be in communication with each other to enhance the understanding of the invention and what is believed to be its full range of potential applications. To assist the screening expert with their initial patentability analysis, a state-of-the-art patent search can be conducted to reveal prior art patents that may be material to the patentability of the invention. The screening expert, if not a patent lawyer, can seek the advise of one on a team of legal experts, as discussed hereinafter, for their opinion on patentability. Ideas that are not likely patentable or not likely to generate an acceptable level of commercial interest are rejected. One significant distinction from invention review committees used by larger corporations is that the screening expert is not looking for the idea to be commercially relevant in one particular industry, but rather their review for commercial viability is across a wide range of often disparate industries to which the idea might apply. The screening expert may interact with the database by means of an interface which allows the screening expert to electronically notify the submitter that the idea has been rejected. In such circumstance, the relevant information in the database regarding the idea is purged to provide protection against later claims of misappropriation. In the case of ideas submitted through other media, the information is returned or destroyed as appropriate.

The remaining database information of accepted ideas is made accessible to review boards of preselected experts. Each review board is composed of professionals in disciplines such as e-commerce, product development, marketing, manufacturing, engineering, and legal in the same industry. There is preferably a separate review board for each industry, such as pharmaceuticals, consumer products, communications, etc. In one form of the invention, database information on newly accepted ideas is routed automatically to the relevant review boards representing the industries most likely to have interest in the idea. In this regard, an extremely broad view of the invention is adopted so as to allow a wide range of industry boards to consider applications the invention may have in their field of specialty. The screening expert who initially reviewed the information packet can be assigned thereto to promote its merits to the various subsequent layers of review through which the idea proceeds, as described herein. The review boards collectively function to identify all of the potential commercial applications for the idea across a variety of industries. While the submitter may contemplate a particular industry or industries where their invention will find utility, the industry experts may be able to broaden its application such as due to their unique understanding and insights that they have developed through their industry experience and research as to emerging trends in their fields. The review boards can further refine, adapt and target the idea to those applications having a reasonable likelihood of commercial acceptance. Thus, one or more marketing experts may identify market needs which would be met by certain embodiments of the idea in a given industry. Technology experts may identify other technologies that may compete with the new idea in such markets. Product development and manufacturing experts may assess the cost of developing and manufacturing the new idea into salable products, compared with the cost of products utilizing competing technology. The expert review boards may also develop sales and profitability forecasts for identified potential products embodying the idea, which may be utilized to determine whether to pursue the idea, which markets have realistic potential licensors for the idea, and develop an appropriate budget for obtaining patent protection.

With respect to the manufacturing experts, they can be provided with access to prototyping and manufacturing equipment and facilities to allow them to better determine the likely advantages or disadvantages that may be encountered during large scale production of an item. This information can be used by these experts to further improve and refine the product or process to its most commercially efficient form. These adaptions of the product/process for optimized manufacturing purposes can strengthen their patent(s) or themselves be the subject of separate patent protection, which determination can be made with input from the other boards such as the strategies and legal boards, as described more fully hereinafter.

In a preferred form of the invention, such expert inputs are made to the idea database and thereby accessible to the entire expert board for appropriate communication and feedback. This can be accomplished using a wide area network (WAN) such as a secured Internet connection or an Intranet to a limited number of users, or within a business organization. In this manner, the collective expertise of the expert boards is utilized to develop and broaden the idea for targeting to various industries and markets thereby adding commercial value. Perhaps most importantly, the idea can be altered or may spawn new and different solutions to the problem an idea was addressing by the various experts whose input is solicited. Accordingly, the original idea does not remain a static packet of information as it proceeds through the system of the present invention, and instead is adapted to its most practical and efficient form based on factors such as market need, likely market acceptance, etc., to maximize the revenue that can be expected therefrom. In this manner, it is contemplated that each patent obtained via the present system and method will have co-inventors including the original submitter of the idea along with those persons employed by the proprietor of the present system that provide inventive contributions to the further development of the idea. The expert review board members may be in-house employees, but are preferably employees of outside companies and universities, etc. engaged in a wide range of industries and in a variety of remote locations with respect to each other so that they are closely familiar with the peculiarities of the forces shaping the market in their locale. By means of the networked environment of the present invention, a wide range of business and other expertise can be accessed in developing ideas without employing a large internal staff. However, the board members will have an employment agreement with the system proprietor detailing their obligations to assign their rights in any system patent on which they may be co-inventor.

One important aspect of the present invention is in the use of a board of strategic product development and marketing experts that can be composed of board members drawn from any of the other expert boards. Their goal is to keep close track of emerging trends across a range of industries, so that they in conjunction with other expert boards determine those ideas and adaptations or refinements thereof that may have relevance in particular markets, whether or not this relevance was recognized by the inventor. For instance, the strategy board can have market landscape maps that plot industry growth areas versus actual implementation or commercialization of products by the industry in the growth areas. In this manner, where an idea has relevance in several industries, the industries in which the field is more open in terms of the number of competitive products attempting to gain market share can be readily identified, and the focus of the further development of the idea can be shifted to those growth industries.

The idea database is also accessible by legal experts who function to form a strategic patent position through the development and filing of one or more patent applications covering the original idea and further developed aspects thereof. The patent attorneys can work in close conjunction with the strategy board and utilizing the state-of-the-art search and other subsequent prior art searches that may be conducted as the idea progresses through its review by the boards and is further developed provide input as to the likely scope of patent protection that can be expected, and in which fields of endeavor. The attorneys via known patent searching techniques and in a manner akin to the previously-described landscape maps can map the patent terrain in the various industries to which an idea has been targeted to identify industry and particular organizations' strategies in their intellectual property protection, whether would be competitors are developing similar products, and to determine the strength of patent protection that should be available in a field. The latter is particularly valuable where an idea has been targeted to an emerging market or technology, and a patent can be positioned as the dominating patent so as to provide exclusive rights with respect to a technology area expected to generate extensive market interest. In this manner, the patent's value is significantly increased with respect to the licensing revenue it can be expected to generate as companies will have to obtain permission from the patent holder to enter the protected market with their competing products utilizing the core enabling technology protected by the patent. On the other hand, the patent map may indicate that a certain field is very active in terms of innovations that are subject to patent protection which may dictate that a certain idea be targeted to a different field in which it has commercial value.

Of course, even if a dominating patent is not available or the patent landscape is crowded, the value of an idea these areas is still assessed with respect to projected potential economic gains to ultimately determine whether the idea should still be pursued in particular fields or markets. This determination is also informed by other ideas in the pipeline of the present system or that are already patented which originated from different submitters and that can be pooled together with the idea under consideration to present a block of patents and/or technology know-how that can be licensed or sold together to interested companies for greater value. Accordingly, the present system alters the economic analysis a submitter may normally undertake as to whether to pursue their idea as by the aforedescribed pooling, the present system allows for a greater tolerance for the risks associated with the resources necessary to properly protect and market an invention over that which a submitter may be willing to undertake.

This is also true of companies who may want to sell or license patented technology particularly where it is not aligned with their core business or is not directed to those areas identified as future growth markets for the company. While these companies may not feel an investment in the patent makes economic sense given the prevalent market trends and returns that can be expected from sale or licensing revenues, the present system may identify other markets not a part of the core business of the company where the patented technology may be commercially valuable and/or may have the ability to pool the patents with other ideas/patents already in the system in a commercially valuable manner. Thus, the system herein can more readily develop and provide potential purchasers or licensors of the system's patented technology patent protected entry into technologies and markets via patents directed to core technology necessary to compete, for example, in an emerging market or by blocks of patents that cover a wide variety of aspects of the technology relevant in a particular market.

By utilizing this unique network of multi-disciplinary experts, the method of the present invention permits the strategic drafting of patent applications to broadly protect and target all of the specific applications of the idea that have realistic commercialization potential. This is in contrast to traditional methods by which patent applications are drafted based only on the inputs of the individual inventor and the patent attorney, without the benefit of a persons experienced in turning ideas into successful commercial products and/or processes across a range of industries. At the same time, patent counsel may also input advise regarding the patentability of the idea into the idea development database to assist in identifying ideas which are both commercializable and protectable under the patent system.

In a further aspect of the invention, the commercially important technologies developed and patented through the networked interactive method described above are strategically provided to targeted business entities across a number of industries. Thus, for example, the experts involved in developing the original idea into patented technology may access a related database of resulting patents. The experts may also receive automated electronic mailings of issued patents that may be relevant to an expert's industry or area of expertise. To this end, the patent attorneys on the legal expert board can have patents checked that issue after a patent in the system of the invention to determine which subsequent patents cite the system's patents as prior art. These citing patents may be directed to commercial products that infringe the cited system's patents, and also provide valuable competitive information as to which companies are active in fields that are the same or similar to that of the products or processes covered by the system's patents and who may be willing to purchase or license these patents.

This expert network may thereby assist in identifying companies interested in purchasing or licensing one or more particular patents and those for which purchasing or licensing of the technology covered by the patent(s) is necessary to avoid infringing. The patents in turn are offered for sale or licensing to these targeted potential licensees. In this manner, the experts involved in developing the patents toward maximum commercial relevance may then assist in placing the patented technology in particular applications of interest.

A database of patented technologies may also be accessed by selected business entities. Entities interested in licensing a particular patent may participate in regulated, competitive bidding for a license on-line in the networked system herein. A website can be provided that includes the patents eligible for licensing (i.e., those that are not already subject to exclusive licenses) with the site accessible via a password and credentials for personnel of preapproved subscriber companies or organizations. Further, specific types of personnel can be provided with different levels of access to the site such as those who can only review the patents for license and others who can actually place bids. The website is preferably structured to organize the system's patents by technology or market or both with individual patents listed in each field in which they are believed to provide coverage. An e-mail notification system may be provided for new patents in selected fields of interest to system subscribers. A short description of the patented technology, perhaps taken from the written text of the patent itself, can be provided to assist the patent reviewer. In the same manner, a separate web page having a description of submitted ideas that are available for purchase or license can be created for access by those who have established confidentiality agreements with the system proprietor. This page can also include the patents and be structured so that related blocks of patents and ideas are organized together. The combination of targeting by the experts and access to a structured database of patent technologies and/or technology know-how will result in substantial royalty revenues. Further, it is submitted that such a method will be self-perpetuating in that as it can be shown that significant economic returns can be obtained with little or no up-front costs for the idea submitters, there will be large incentive in place for additional submitters to consider use of the present system.

The submitter of the original idea is compensated based upon the percentage of the sale price or royalty revenues earned from licensing of know-how or patents directed to their idea or of subject matter developed by way of their idea and patented. Such royalties are often minimal or non-existent for individuals who endeavor to develop and patent an idea on their own, without the multi-disciplinary expert analysis available throughout the method of the present invention. Similarly and as previously discussed, even those companies that are relatively sophisticated with respect to their intellectual property activities usually have no desire to develop and market their innovations that do not fit within their organization's strategic goals. These innovations whether unpatented or patented, can be licensed or sold to the system operator herein to realize profits for the company that otherwise would be non-existent. At the same time, the method of the invention allows the operator of the integrated expert network to maximize the number of new ideas developed, and thereby the income earned from its retained share of generated sales income or royalties. An upfront legally binding agreement with the submitters of ideas and/or patents will establish the respective rights of the parties in the intellectual property and the respective sharing of revenue therefrom, as previously mentioned.

Another aspect of the invention is that because of the unique assemblage of multi-disciplinary experts of the present system, and in particular boards that have members that are highly experienced with and closely in tune with the intellectual property considerations of achieving commercial success in their particular field of endeavor, the system herein is uniquely positioned to offer intellectual property management services to companies. These services can improve the revenue stream currently generated by the company's investment in intellectual property by use of many of the tools already described with respect to the intake and development of ideas and/or patents for maximum commercial gain. Since the system is not limited by any particular company's view of their markets, their innovations can be better developed without being dismissed because they do not fit in with the company's strategic goals.

To this end, the IP portfolio management can set up a detailed record keeping requirement in each company to which management services are provided to ensure all innovations are properly considered within the context of the abilities of the present system to realize income from development of the idea. For this purpose, each idea would proceed through the system in the same manner as previously described so as to further refine the invention, target it to the broadest range of applications that are of commercial value to the system, and obtain patent protection therefor consistent with the decisions on which fields it should be targeted. Also and as previously mentioned, a service may be offered to take a company's patent(s) or patent application(s) and run it through the present system and method to broaden, target and increase it's economic value.

After issuance, the system can use the previously-described methods where competitive intelligence is utilized to identify potential purchasers/licensors and/or infringers to generate income. Because of its large trade in patented innovations and need to generate revenue directly from these system patents for self-preservation, the system herein has a continuing incentive and mission to keep closely apprised of competitive activity and new developments across the range of fields for which its services are offered. In this way, the present system can offer monitoring and patent enforcement services that are improved over what a particular company can accomplish where its internal resources may already be spread thin in an effort to reduce overhead for maximizing profits. Usually companies rely on information received from their sales force regarding competitor's activities which may not always be very accurate and not always relevant where they are not aware of the particulars of their own company's patent holdings. In contrast, the expert boards of the present system stay acutely aware of precisely what is occurring in their respective markets and know with precision the patent position of the system's patents via the intercommunication with the various other boards as ideas and patents enter and proceed through the system as this is necessary so that they can provide their input as to a particular idea's/patent's value in relation to their industry and the industry patent position established with the system patents currently for sale or license, as previously described.

The present invention is described in the context of the world wide web. However, it may find application in any network environment where one or more remote database are accessible for idea originators and to a number of expert review boards and to preapproved potential licensees. In such environments, individuals can submit ideas into an expert accessible database for receiving expert inputs regarding the developments and commercialization of the idea and the identity of companies potentially interested in licensing patented technology related to the idea, and broad patents are thereby obtained and submitted for sale or licensing to a large number and wide variety of different types of companies or organizations.

I claim:

1. A system for developing commercially valuable intellectual property rights, the system comprising:
a communication path for allowing independent sources including individuals or organizations from a plurality of locations that are remote with respect to each other to send information packets for receipt by a predetermined host for evaluation;
expert review boards of the host each associated with a specific field of endeavor, the fields including different technology or industry applications with the review boards receiving preselected ones of the information packets for developing the preselected information into commercially valuable forms thereof; and
a structured database having the preselected ones of the information packets received from the independent sources organized in the developed forms by the applications thereof for review by potential purchasers or licensors of the developed forms to generate maximized revenue for the sources of the information packets and the host therefrom.

2. The system of claim 1 wherein the communication path and the database include web pages of a predetermined website that allow for preapproved access thereto upon preapproval from the host.

3. The system of claim 1 including one of a wide area network system and an Intranet system to allow intercommunication between members of each board and of other boards with regard to inputs and feedback for developing the information packets.

4. The system of claim 1 wherein the received information includes innovations in text or drawing form received electronically by the host over the communication path.

5. The system of claim 4 wherein the communication path is electronically encrypted.

6. The system of claim 1 wherein the communication path is established over an internet of linked computers for providing wide access to a large number of remote independent sources of information packets.

7. The system of claim 1 wherein one of the fields of the expert review boards is legal for obtaining patent protection on the developed forms of the preselected information packets, and the database includes issued patents.

8. The system of claim 7 wherein the patent database has a restricted access protocol to allow for preapproved entities to purchase or license desired ones of the patents.

9. The system of claim 1 wherein the expert review boards include a screening board for preselecting those information packets based on predetermined factors relating to commercial value to be sent on to other review boards for development.

10. The system of claim 9 wherein the predetermined factors include markets in which the information can be applied, status of competitive activity in the applicable markets, patentability of the information and strength of patent protection available.

11. The system of claim 1 including a second communication path to allow independent companies to make requests for specific desired innovations, and
a second database having the innovation requests posted thereto and being accessible by the independent sources to provide information packets in response to the requests for consideration and purchase by the companies.
